(19) United States
(12) Patent Application Publication
(10) Pub. No.: US 2016/0171326 A1
(43) Pub. Date: Jun. 16, 2016

(54) IMAGE RETRIEVING DEVICE, IMAGE RETRIEVING METHOD, AND NON-TRANSITORY STORAGE MEDIUM STORING IMAGE RETRIEVING PROGRAM

(71) Applicant: Olympus Corporation, Tokyo (JP)

(72) Inventors: Kazuhiko SHIMURA, Hachioji-shi (JP); Yoshiyuki FUKUYA, Sagamihara-shi (JP); Kazuo KANDA, Higashiyamato-shi (JP)

(21) Appl. No.: 14/962,303

(22) Filed: Dec. 8, 2015

(30) Foreign Application Priority Data
Dec. 10, 2014 (JP) 2014-249974

(51) Int. Cl. G06K 9/20; G06F 17/30; G06K 9/62

(52) U.S. Cl. CPC G06K 9/2081; G06K 9/6215; G06F 17/30247

(57) ABSTRACT

An image retrieving device includes display unit, a selecting unit, and a control unit. The display unit displays a first image and a second image. The selecting unit selects a first region of a part of the first image displayed on the display unit by a user operation. The control unit searches for a second region of the second image corresponding to the first region when the first region of a part of the first image is selected by the selecting unit.

### CROSS-REFERENCE TO RELATED APPLICATIONS

This application is based upon and claims the benefit of priority from the prior Japanese Patent Application No. 2014-249974, filed Dec. 10, 2014, the entire contents of which are incorporated herein by reference.

### BACKGROUND OF THE INVENTION

1. Field of Invention

The present invention relates to an image retrieving device, an image retrieving method, and a non-transitory storage medium storing an image retrieving program.

2. Description of Related Art

Generally, a device such as a digital camera or a personal computer comprising a display unit is capable of displaying various images. For example, a digital camera described in Japanese Patent Application KOKAI Publication No. 2008-72261 is such that, after a plurality of confirmation images are cut out from a photographed image acquired by photographing, the photographed image and the plurality of confirmation images are displayed in a prescribed section of a multi-preview screen of a display unit. Having looked at the photographed image and the confirmation images displayed on the multi-preview screen, a user may collectively confirm the state of a plurality of parts of the photographed image. The user may improve the efficiency of confirming the photographed image using this digital camera.

When the number of photographed images increases, the number of confirmation images that must be confirmed also increases, which consequently deteriorates confirmation efficiency.

### BRIEF SUMMARY OF THE INVENTION

According to a first aspect of the invention, there is provided an image retrieving device comprising: a display unit which displays a first image and a second image; a selecting unit which selects a first region of a part of the first image displayed on the display unit by a user operation; and a control unit which, when the first region of a part of the first image is selected by the selecting unit, searches for a second region of the second image corresponding to the first region.

According to a second aspect of the invention, an image retrieving method comprising: displaying a first image and a second image on a display unit; determining whether or not a first region of a part of the first image is selected by a selecting unit; and when the first region of the part of the first image is selected by the selecting unit, searching for a second region of the second image corresponding to the first region.

According to a third aspect of the invention, a computer-readable non-transitory storage medium stores an image retrieving program, the storage medium comprising: displaying a first image and a second image on a display unit; determining whether or not a first region of a part of the first image is selected by a selecting unit; and when the first region of the part of the first image is selected by the selecting unit, searching for a second region of the second image corresponding to the first region.

According to a fourth aspect of the invention, an image retrieving device comprising: a display unit which displays a first image; a selecting unit which selects a region of a part of the first image displayed on the display unit by a user operation; and an image retrieving unit which searches for a second image comprising a specific region similar to the region selected by the selecting unit from a recording unit.

According to a fifth aspect of the invention, an image retrieving method comprising: displaying a first image on a display unit; and searching for a second image comprising a specific region similar to a region of a part of the first image selected by a selecting unit from a recording unit.

According to a sixth aspect of the invention, a computer-readable non-transitory storage medium stores an image retrieving program, the storage medium comprising: displaying a first image on a display unit; and searching for a second image comprising a specific region similar to a region of a part of the first image selected by a selecting unit from a recording unit.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute apart of the specification, illustrate embodiments of the invention, and together with the general description given above and the detailed description of the embodiments given below, serve to explain the principles of the invention.

FIG. 1 is a block diagram showing an example of a configuration of an image retrieving device according to a first embodiment of the present invention.

FIG. 2A and FIG. 2B are diagrams explaining a brief overview of an operation of the image retrieving device according to the first embodiment of the present invention.

FIG. 3 is a flowchart showing an example of an operation of the image retrieving device according to the first embodiment of the present invention.

FIG. 4A, FIG. 4B, FIG. 4C, FIG. 4D, FIG. 4E, and FIG. 4F are diagrams explaining display examples of images in response to an operation performed by a user.

### DETAILED DESCRIPTION OF THE INVENTION

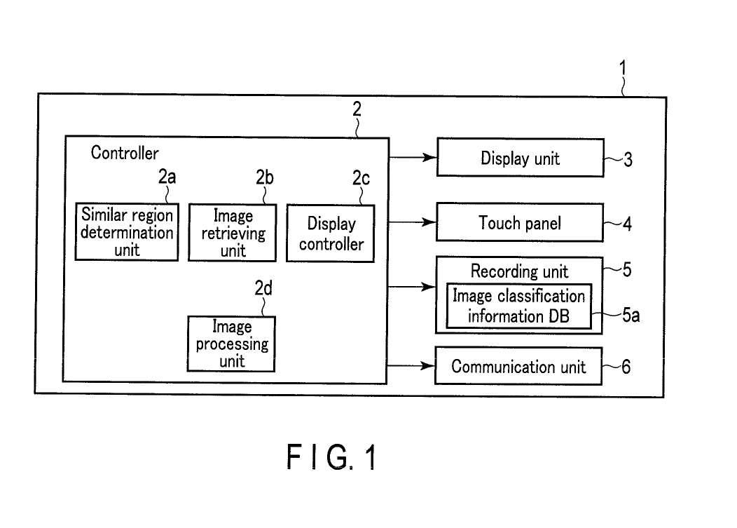

A configuration of an image retrieving device according to a present embodiment will be explained. FIG. 1 is a block diagram showing a configuration of an image retrieving device 1 according to the present embodiment. The image retrieving device 1 is a tablet terminal, a smart phone, a digital camera, and the like.

The image retrieving device 1 comprises a controller 2, a display unit 3, a touch panel 4, a recording unit 5, and a communication unit 6.

The display unit 3 is, for example, a Liquid Crystal Display (LCD) or an organic EL display, etc., and displays on a display surface an image based on image data.

The touch panel 4 is provided on the display surface of the display unit 3 in an overlapping manner. Location information on the panel which is touched by a fingertip or a pen point, etc. of a user is detected by one of the systems among the detection systems of, for example, a resistive film type, an electrostatic capacitance type, an optical type, or an electromagnetic induction type. By detecting the location information on the panel, a location on the display surface of the display unit 3 designated by a user is determined. The location on the display surface of the display unit 3 designated by a user may also be determined by utilizing a signal obtained from a cross key, etc. Hereinafter, the touch panel 4 and the cross key, etc. will be collectively referred to as a selecting unit for selecting a location on the display surface of the display unit 3 by an operation performed by a user.

The recording unit 5 is a recording medium, such as a flash memory, in which content is retained even when power is cut off. The recording unit 5 records a program for operating the image retrieving device 1 and image data, and thumbnail data corresponding to the image data, etc. The recording unit 5 comprises an image classification information database (DB) 5a. The image classification information DB 5a stores information indicating the classification of image data. In the present embodiment, image data is classified into image data having similar characteristics. As information for indicating classification, the image classification information DB 5a stores classification items and information for indicating which image data is associated with each of the classification items. A portion that records image data in the recording unit 5 may be configured to be detachable.

Under the control of the controller 2, the communication unit 6 transmits data to an external device by a wired or wireless connection.

The controller 2 is, for example, configured by a CPU or ASIC, and comprises a similar region determination unit 2a, an image retrieving unit 2b, a display controller 2c, and an image processing unit 2d. When a part of a region of one of two images displayed on the display unit 3 is selected through the touch panel 4, the similar region determination unit 2a determines a region similar to the selected region from the other image. The region similar to the selected region is, for example, a region having the closest degree of matching with the region selected in the image. The match does not have to be exact. When a part of a region of one of two images displayed on the display unit 3 is selected through the touch panel 4, the image retrieving unit 2b searches among the images recorded in the recording unit 5 for an image that includes a region similar to the selected region. The display controller 2c drives the display unit 3 and processes a signal input to the display unit 3 by, for example, displaying an image on the display unit 3 at a prescribed magnification factor. The image processing unit 2d cuts out a region of the image selected by the touch panel 4.

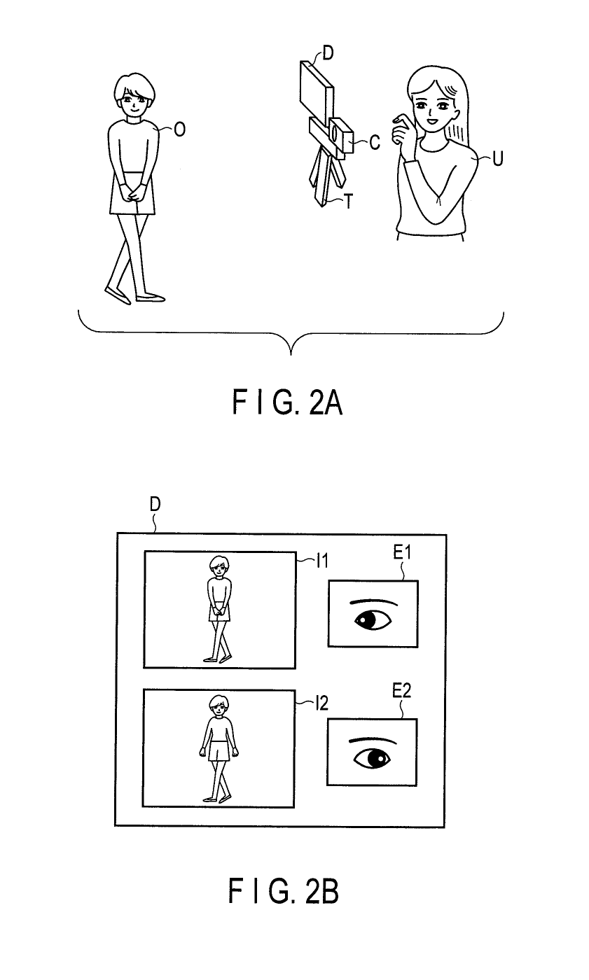

A brief overview of an operation of the image retrieving device 1 according to the present embodiment will be explained with reference to FIG. 2A and FIG. 2B. FIG. 2A is a diagram for explaining an example of a user selecting a photographed image. As shown in FIG. 2A, a user U photographs an object, here person O, by camera C. The camera C comprises a display unit for, for example, displaying a live view or a photographed image. The camera C is mounted on a tripod with a display terminal D as an example of the image retrieving device 1. This display terminal D also comprises a display unit for displaying an image. The display unit of the display terminal D is larger than the display unit of the camera C. Furthermore, the camera C and the display terminal D are able to communicate with each other. Therefore, through communication image data is transmitted from, for example, the camera C to the display terminal D. The user considers obtaining a plurality of photographed images of the person O photographed by using the camera C, then selecting a desired image from these photographed images. As the selection standard, for example, a person O's expression, such as the state of the person O's eyes, may be considered.

In the case where the user U selects a desired image from the photographed image, it is easier to confirm the details of the photographed image and select a desired image by looking at the photographed image displayed on a large display unit. Therefore, in order to confirm the photographed image by the large display unit provided on the display terminal D, the user U transmits a plurality of photographed images from the camera C to the display terminal D to have the photographed images displayed on the display unit of the display terminal D.

FIG. 2B is a diagram showing a display example of the photographed image on the display unit of the display terminal D of the present embodiment. In the example of FIG. 2B, the display terminal D arranges and displays two images, i.e. photographed image I1 and photographed image I2, on the display unit. The display unit of the display terminal D is larger than the display unit of the camera C. Therefore, the user is capable of visually recognizing the difference between the two photographed images. In the present embodiment, the display unit of the display terminal D displays an enlarged image E1 that corresponds to the photographed image I1, and an enlarged image E2 that corresponds to the photographed image I2. The enlarged image E1 is an image obtained by enlarging a region of a part of the photographed image I1, for example, a peripheral region of an eye. The enlarged image E2 is an image obtained by enlarging a region corresponding to the photographed image I1, i.e. the peripheral region of an eye, in the photographed image I2. Enlarging and displaying a region of a part of the photographed image allows a user to visually recognize details of a photographed image more easily.

In the present embodiment, when a region of a part of the photographed image, for example, a peripheral region of an eye of the photographed image I1, is selected by the user, a region of the photographed image I2 corresponding to this region is searched. Then, the enlarged image E2 of the searched region is displayed. This allows the user to compare the photographed image I1 with the photographed image I2 without having to select a portion corresponding to the photographed image I1 from the photographed image I2. Therefore, the user is able to select an image more efficiently.

In the present embodiment, if an enlarged image, for example, the enlarged image E2, is selected, a different photographed image including a region corresponding to the enlarged image E2 is searched. Then, the photographed image that has been searched is displayed. This allows the user to easily select a photographed image for comparison.

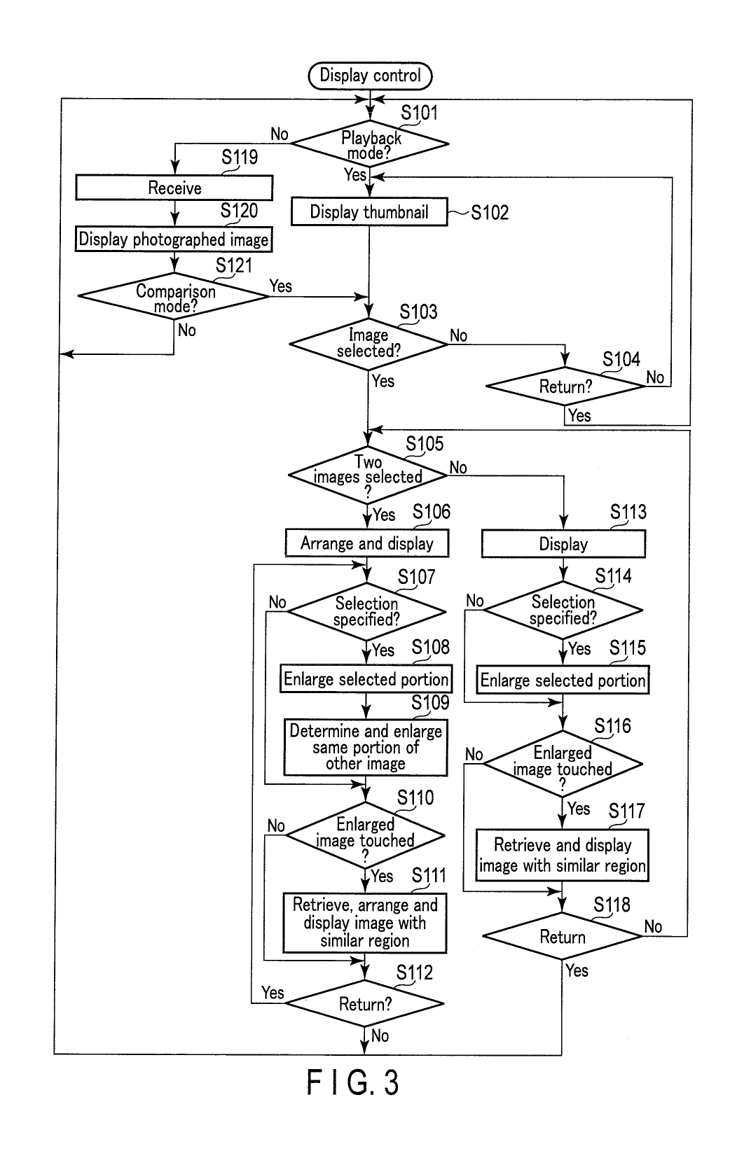

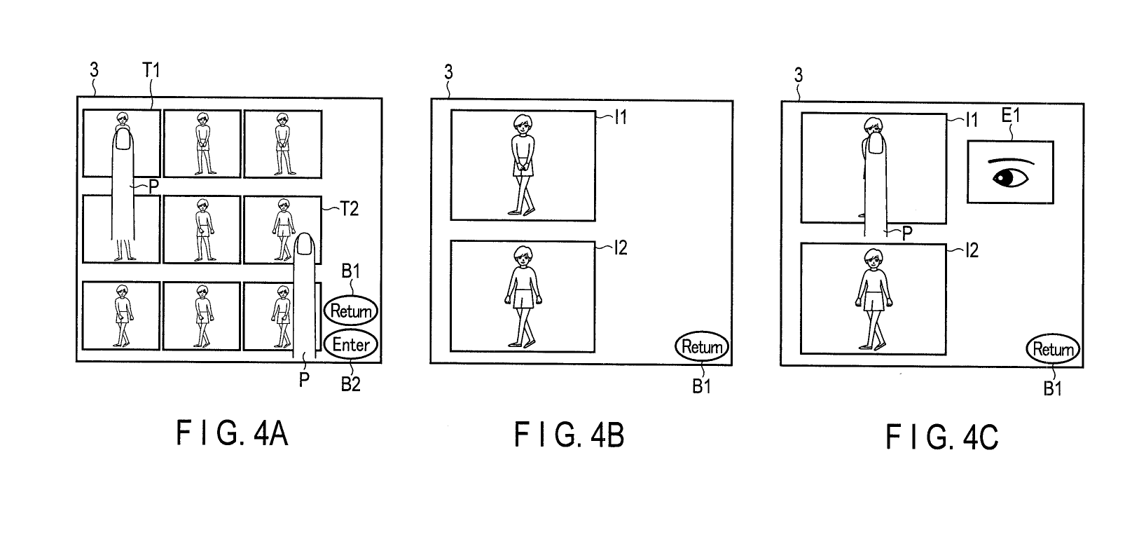

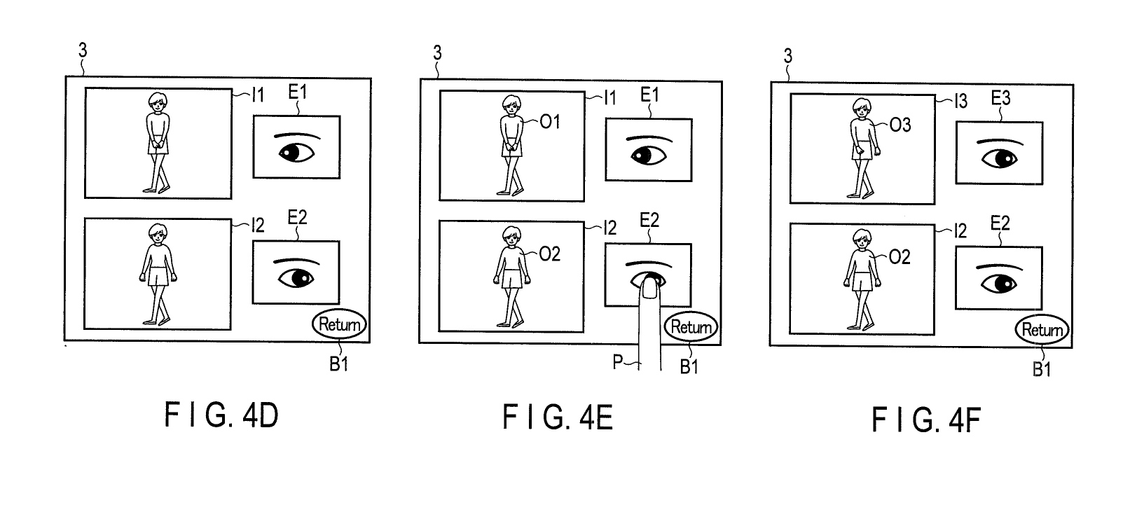

The operation of the image retrieving device 1 according to the present embodiment will be explained. FIG. 3 is a flowchart showing the operation of the image retrieving device 1 of the present embodiment. The image retrieving device 1 starts display control when, for example, power is turned on. With reference to FIG. 4A to FIG. 4F, a display example of an image in response to an operation performed by the user will be explained.

In step S101, the controller 2 determines whether or not a playback mode has been selected. In step S101, when the playback mode is determined as being selected, in step S102 the controller 2 reads out thumbnail data from the recording unit 5 and displays a list of the thumbnails on the display unit 3. FIG. 4A shows an example of a list display. As shown in FIG. 4A, in the case of list display, a return button B1 and an enter button B2 are displayed with the thumbnails. The return button B1 is a button for returning the process to a previous process. In the case of list display, by referring to the image classification information DB 5a, the controller 2 may perform list display for only the thumbnails of images belonging to the same classification. Subsequently, the process proceeds to step S103.

In step S103, the controller 2 determines whether or not a first thumbnail has been selected by the user. For example, when the touch panel 4 on the display surface of the display unit 3 on which the thumbnail is displayed is touched by the user, the controller determines a thumbnail overlapping the touched location as being selected. In step S103, when it is determined that the first thumbnail has not been selected by the user, the process proceeds to step S104.

In step S104, it is determined whether or not the process returns to step S101. In step S104, when the process is determined as returning to step S101, for example, when the return button B1 is selected, the process returns to step S101. In step S104, when the process is determined as not returning to step S101, the process returns to S102.

In step S103, when the first thumbnail is determined as being selected by the user, in step S105, the controller 2 determines whether or not a second thumbnail has been selected by the user. In step S105, when the second thumbnail is determined as being selected by the user, the process proceeds to step S106. A state in which the second thumbnail has been selected by the user is a state, for example, in which the enter button B2 has been selected after the second thumbnail has been selected. Meanwhile, a state in which the second thumbnail has not been selected by the user is a state, for example, in which the enter button B2 has been selected after the first thumbnail has been selected.

The user selects one or two thumbnails by a fingertip P, etc. while looking at the thumbnails list-displayed on the display unit 3 in the manner shown in FIG. 4A. As shown in FIG. 4A, for example, two thumbnails, i.e. thumbnail T1 and thumbnail T2, are selected by, for example, the fingertip P. In these thumbnails, for example, a person is displayed.

The explanation will return to FIG. 3. In step S106, the controller 2 respectively reads out image data corresponding to the two thumbnails selected by the user from the recording unit 5, and arranges and displays two images based on the image data on the display unit 3.

FIG. 4B is a diagram for explaining an example of a display when the thumbnails are selected. After the thumbnail T1 and the thumbnail T2 are selected by the user, as shown in FIG. 4B, an image I1 corresponding to the thumbnail T1 and an image I2 corresponding to the thumbnail T2 are arranged and displayed on the display unit 3 with the return button B1. The return button B1 is, for example, a button for returning the process to step S101, i.e. returning the process to selecting the playback mode.

The explanation will return to FIG. 3. In step S107, the controller 2 determines whether or not a part of a region of the image has been selected by the user in the display unit 3. In step S107, when apart of the region of the image is determined as not being selected by the user, the process proceeds to step S110. In step S107, when a part of the region of the image is determined as being selected, in step S108, the controller 2 displays an enlarged image of the region selected by the user on display unit 3. Subsequently, the process proceeds to step S109.

FIG. 40 is a diagram for explaining an example of a display when a part of the region of the image I1 has been selected. As shown in FIG. 4C, when a peripheral region of an eye of a person is selected by, for example, the fingertip P, an enlarged image E1 of this region is displayed on the display unit 3.

The explanation will return to FIG. 3. In step S109, the controller 2 determines a region corresponding to the region of the image I1 that is selected by, for example, the fingertip P, namely a region the enlarged image E1 shows distinguished from the image I2, and displays the enlarged image of the distinguished region on the display unit 3. Subsequently, the process proceeds to step S110. For example, in the case where the region of the image I1 that is selected by the fingertip P for example, is a peripheral region of an eye of a person, the controller determines, for example, a region that matches the pattern of this peripheral region from the image I2.

FIG. 4D is a diagram for explaining an example of displaying the enlarged image E2. In the case where a part of the region of the image I1 is selected by the user, an enlarged image E2 of a region corresponding to the selected region is displayed on the display unit 3.

The explanation will return to FIG. 3. In step S110, the controller 2 determines whether or not the enlarged image E1 or the enlarged image E2 has been selected by the user. In step S110, when neither the enlarged image E1 nor the enlarged image E2 have been determined as being selected by the user, the process proceeds to step S112. In step S110, when the enlarged image E1 or the enlarged image E2 has been determined as being selected by the user, the process proceeds to step S111.

FIG. 4E is a diagram for explaining an example of a circumstance in which an enlarged image is selected by the user. For example, when the user wishes to select a desired image, the user selects an enlarged image having a desired characteristic between the enlarged image E1 and the enlarged image E2. In FIG. 4E, the user wishes to select an image according to the eye of the person in the image. The eye of a person O1 shown in the image I1 has a different characteristic from the eye of a person O2 shown in the image I2. For example, the line of sight of the person O1 in the image I1 is directed frontwards while the line of sight of the person O2 in the image I2 is directed sideways. Such difference becomes clear in the enlarged image. For example, in the case where the user desires an image in which the line of sight is directed frontwards, the enlarged image E2 is selected.

The explanation will return to FIG. 3. In step S111, the controller 2 retrieves image data comprising a region similar to the region shown by the enlarged image selected by the user from the recording unit 5. Subsequently, the controller 2 replaces the image unselected by the user with the image based on the retrieved image data and the enlarged image obtained by enlarging a region similar to this image, and displays them. In the example, the unselected image is the image I1 and the enlarged image E1. Subsequently, the process proceeds to step S112.

FIG. 4F is a diagram for explaining an example of displaying the retrieved image. In the case where the enlarged image E2 is selected by the user, as shown in FIG. 4F, the display of the display unit 3 is replaced from the image I1 and the enlarged image E1 to an image I3 and an enlarged image E3 having a region similar to the enlarged image E2. The object of the image I3 and the enlarged image E3 is person O3. The enlarged image E3 is an enlarged image of a peripheral region of the eye of the person O3. The line of sight of the person O3 is directed frontwards in the same manner as the enlarged image E2.

The explanation will return to FIG. 3. In step S112, it is determined whether or not the process will return to step S107. When it is determined that the process will return to step S107, for example, when the return button B1 is selected, the process returns to step S107. When it is determined that the process will not return to step S107, the process returns to step S101.

In step S105, when two thumbnails are determined as not being selected by the user, that is, when one thumbnail is selected, the process proceeds to step S113.

In step S113, the control unit 2 reads out image data corresponding to the one thumbnail selected by the user from the recording unit 5, and displays an image based on this image data on a part of the region of the display unit 3. Subsequently, the process proceeds to step S114.

In step S114, the controller 2 determines whether or not a part of the region of the image is selected by the user in the display unit 3. In step S114, when a part of the region of the image is determined to have not been selected by the user, the process proceeds to step S116. In step S114, when a part of the region of the image is determined to have been selected by the user, in step S115, the controller 2 arranges and displays the image and the enlarged image of the region selected by the user on the display unit 3. Subsequently, the process proceeds to step S116.

In step S116, the controller 2 determines whether or not an enlarged image has been selected by the user. In step S116, when the enlarged image is determined to have not been selected by the user, the process proceeds to step S118. In step S116, when the enlarged image is determined to have been selected by the user, the process proceeds to step S117.

In step S117, the controller 2 retrieves image data comprising a region similar to the region shown by the enlarged image selected by the user from the recording unit 5. Subsequently, the controller 2 replaces the image and the enlarged image displayed on the display unit 3 with the image based on the retrieved image data and the enlarged image obtained by enlarging a region similar to this image and displays them. Subsequently, the process proceeds to step S118.

In step S118, it is determined whether or not the process returns to step S105. In step S118, when it is determined that the process returns to step S105, for example, when the return button B1 is selected, the process returns to step S105. In step S118, when it is determined that the process will not return to step S105, the process returns to step S101.

In step S101, when it is determined that the playback mode has not been selected, in step S119 the controller 2 starts communication with an external device, for example, a camera, and receives photographed image data from the camera. Subsequently, the process proceeds to step S120.

In step S120, thumbnails based on the photographed image data received from the external device are list-displayed. Subsequently, the process proceeds to step S121.

In step S121, the controller 2 determines whether or not the current mode of the image retrieving device 1 is a comparison mode. The comparison mode is a mode for arranging and displaying two photographed images on the display unit 3 as in the process according to step S106 to step S112 in which two images are arranged and displayed on the display unit 3. In step S121, when it is determined that the mode is not the comparison mode, the process returns to step S101. In step S121, when the mode is determined to be the comparison mode, the process proceeds to step S103.

In the manner mentioned above, the image retrieving device 1 of the present embodiment arranges and displays two images on the display unit 3, and, when a part of a region of one of the two images is selected by the user, a part of a region of the other image corresponding to this region is selected, and an enlarged image of each of the selected regions is displayed. Further, when an enlarged image of one of the two images is selected by the user, the image retrieving device 1 determines image data comprising a region similar to the enlarged image selected by the user from the image data recorded in the recording unit 5, and replaces the image and the enlarged image which were unselected by the user with the image based on this image data and the enlarged image obtained by enlarging a similar region. Such image retrieving device 1 allows the user to shorten the time for selecting a plurality of images.

Each process carried out by the image retrieving device 1 in the above-mentioned embodiment may be stored as an executable program. The programs are capable of executing the above-mentioned processes by reading the programs stored in the storage mediums of external storage devices, such as a memory card (e.g., a ROM card, or a RAM card), a magnetic disk (e.g., floppy disk (registered trademark), or a hard disk), an optical disk (e.g., a CD-ROM or a DVD), or a semiconductor memory, and allowing the operations to be controlled by the read programs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image retrieving device comprising:
a display unit which displays a first image and a second image;
a selecting unit which selects a first region of a part of the first image displayed on the display unit by a user operation; and
a control unit which, when the first region of a part of the first image is selected by the selecting unit, searches for a second region of the second image corresponding to the first region.

2. The image retrieving device according to claim 1, wherein the control unit displays the first region and the second region on the display unit.

3. The image retrieving device according to claim 1, further comprising an image retrieving unit which searches for an image comprising a specific region similar to the first region or the second region selected by the selecting unit from the recording unit.

4. An image retrieving method comprising:
displaying a first image and a second image on a display unit;
determining whether or not a first region of a part of the first image is selected by a selecting unit; and
when the first region of the part of the first image is selected by the selecting unit, searching for a second region of the second image corresponding to the first region.

5. A computer-readable non-transitory storage medium which stores an image retrieving program, the storage medium comprising:
displaying a first image and a second image on a display unit;
determining whether or not a first region of a part of the first image is selected by a selecting unit; and
when the first region of the part of the first image is selected by the selecting unit, searching for a second region of the second image corresponding to the first region.

6. An image retrieving device comprising:
a display unit which displays a first image;
a selecting unit which selects a region of a part of the first image displayed on the display unit by a user operation; and
an image retrieving unit which searches for a second image comprising a specific region similar to the region selected by the selecting unit from a recording unit.

7. An image retrieving method comprising:
displaying a first image on a display unit; and
searching for a second image comprising a specific region similar to a region of a part of the first image selected by a selecting unit from a recording unit.

8. A computer-readable non-transitory storage medium which stores an image retrieving program, the storage medium comprising:
displaying a first image on a display unit; and
searching for a second image comprising a specific region similar to a region of a part of the first image selected by a selecting unit from a recording unit.
